(19) United States
(12) Patent Application Publication
(10) Pub. No.: US 2009/0133090 A1
(43) Pub. Date: May 21, 2009

(54) METHOD AND SYSTEM OF PROVIDING CONTENT MANAGEMENT FOR A SET-TOP BOX

(75) Inventor: Martin A. Busse, Woburn, MA (US)

Correspondence Address: VERIZON;PATENT MANAGEMENT GROUP, 1320 North Court House Road, 9th Floor, ARLINGTON, VA, 22201-2909, US

(73) Assignee: Verizon Data Services Inc., Temple Terrace, FL (US)

(21) Appl. No.: 11/942,511

(22) Filed: Nov. 19, 2007

(51) Int. Cl. H04N 7/173

(52) U.S. Cl. 725/132

(57) ABSTRACT

An approach is provided for establishing, by a first user (e.g., parent), a user profile on a set-top box that is configured to present a selectable image corresponding to the user profile to a display for selection by a second user (e.g., child). The user profile specifies content that is available to the second user.

### BACKGROUND INFORMATION

With the advent of computers, interactive electronic communications, and the Internet, as well as advances in the digital realm of consumer information, has come a reinvention of conventional entertainment and communication services to enhance programming, recording, gaming, and viewing of multimedia, such as broadcast television programs. Traditionally, broadcast media, being based on pre-computer age technology, developed on its own path, without any regard to other media systems. However, with readily available, cost-effective broadband services, bandwidth intensive applications, such as video streaming and online gaming, have become viable alternatives to legacy broadcast systems.

It is recognized that modern lifestyles have become so reliant on digital interfaces that media devices, such as set-top boxes (STB), are developing into important iconographies of media content accessibility. As such, an increasing number of individuals are utilizing STBs to achieve the advantages of ubiquitous access to information and entertainment. Advances in technology, services, and affordability; however, can be better applied to foster the enrichment of society. For example, the household media environment plays a significant role in the socialization of youngsters. From the kinds of media available, to the extent with which young people are exposed, media plays an inexorable role in what adolescents know, believe, and value. Thus, to a large extent, media dictates how young people learn, interact, and behave.

Therefore, there is a need for an approach that seamlessly provides flexible, efficient techniques to manage content.

### BRIEF DESCRIPTION OF THE DRAWINGS

FIG. 1 is a diagram of a system capable of providing content management for a set-top box, according to an exemplary embodiment;

FIG. 2 is a diagram of a set-top box configured to provide managed content, according to an exemplary embodiment;

FIG. 3 is a flowchart of a process for establishing and/or editing a user profile, according to an exemplary embodiment;

FIGS. 4a-4c are diagrams of user interfaces utilized in the process of FIG. 3, according to exemplary embodiments;

FIG. 5 is a flowchart of a process for presenting a menu of content options based on a selected user profile, according to an exemplary embodiment;

FIGS. 6a and 6b are diagrams of user interfaces utilized in the process of FIG. 5, according to exemplary embodiments; and

FIG. 7 is a diagram of a computer system that can be used to implement various exemplary embodiments.

### DESCRIPTION OF THE PREFERRED EMBODIMENT

A preferred apparatus, method, and software for providing content management for a set-top box are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although various exemplary embodiments are described with respect to a set-top box (STB), it is contemplated that these embodiments have applicability to any device capable of processing audio-video (AV) signals for presentation to a user, such as a home communication terminal (HCT), a digital home communication terminal (DHCT), a stand-alone personal video recorder (PVR), a television set, a digital video disc (DVD) player, a video-enabled phone, an AV-enabled personal digital assistant (PDA), and/or a personal computer (PC), as well as other like technologies and customer premises equipment (CPE).

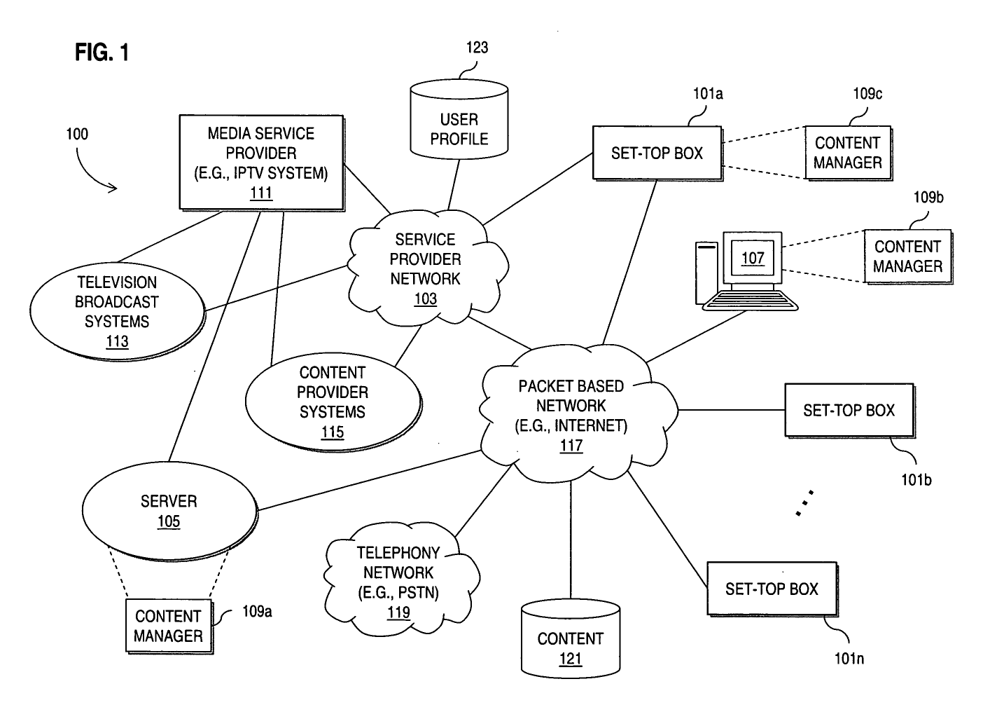

FIG. 1 is a diagram of a system capable of providing content management for a set-top box, according to an exemplary embodiment. For the purposes of illustration, a system 100 for configuring a media-based device (e.g., STB 101a) to present a menu of customized content options (e.g., audio, video, gaming, and/or photographic media instances) to a user based on an associated user profile is described with respect to a service provider network 103. As used herein, the terms media-based device, STB, and user equipment are interchangeable. It is recognized that service providers need to be mindful of consumer demand for increased control over the multimedia entertainment and programming accessible via a media-based device. As such, a system 100 introduces a content management service for one or more set-top boxes 101a-101n, thereby affording substantial convenience and flexibility in controlling available content by consumers. In other words, the content management service of system 100, according to certain embodiments, stems from the recognition that guardians can benefit from more flexible methods to manage content available to dependents. However, little attention has been afforded to extending and enhancing content management features within the entertainment arena, as well as among other communication mediums. Thus, it is apparent that improvements are needed to provide greater control over a media experience.

Service provider network 103 includes a server 105 that implements a content management service, whereby users can access, configure, and modify one or more user profiles specifying content that is available to other users. Namely, the content management service provides guardians ubiquitous control over the media (e.g., broadcast content, digital video recorder (DVR) content, on-demand content, on-demand games, and/or other suitable media, as well as locally stored instances of the same) available to their dependents via a media-based device (e.g., STB 101a). In this manner, a subscriber (e.g., a parent) of the content management service may specify content that is available to one or more dependent users (e.g., a child) and schedule access to that content, via one or more user profiles, so as to enhance the edifying nature of the dependent users' media experience. It is contemplated that system 100 may embody many forms and include multiple and/or alternative components and facilities.

It is observed that television remains the prevalent global medium for entertainment and information as individuals spend a great deal of time tuning into televised media. As such, television services provided over a dedicated network, such as an IPTV (internet protocol television) network, cable network, or satellite network, extend to subscribers an overwhelming choice of multimedia entertainment and programming options. For example, IPTV service providers offer consumers various AV services ranging from multi-channel AV programming that mimics traditional broadcast media, to true “on-demand” programming. These services are further supplemented with interactive AV applications that enable robust programming information, selection and navigation functionality, as well as integrated digital AV recording, and other data services to enhance the AV experience. Moreover, the increasing “richness” of network resources also enables IPTV service providers to extend interactive learning and video game applications to subscribers. As such, television is no longer a passive medium; it is an interactive entertainment encounter capable of endless configuration and personalization.

Given the breadth of content available, parents are confronted with the onerous task of managing the programming and content available to their children. While a wealth of educational and cultural material exists, so too does a large body of objectionable content. For example, parents may, at times, have some success in organizing their children's multimedia experience; however, few parents are able to maintain continuous supervision. In many instances, it is the case that parents are wholly unaware of the content actually being “tuned” into by their children. This is because traditional control techniques are either manual (e.g., based on vacillating parental rules), or reliant upon vague, participatory content ratings that are not always available or, in the mind of some, not always applied commensurately. Further, guardians had to trust their dependents and hope they were not too inquisitive (or desensitized when they were).

As such, the consumer segment is driven, at least in part, by a demand for content management services extended through easily manipulated, intuitive interfaces. Thus, as previously mentioned, various embodiments of system 100 provide consumers convenient access to content management features so as to maximize a dependent's exposure to an enhanced body of edifying media, but at the same time, limiting (if not eliminating) their exposure to inappropriate material.

As seen in FIG. 1, service provider network 103 integrates the television medium with that of the telecommunications, computing, and media environments, thereby broadening the scope of devices and sources available to individuals for obtaining content and controlling access to that media. In this manner, system 100 relieves guardians from the daunting task of having to constantly police their dependents' multimedia environment, by enabling users, via user equipment, such as STBs 101a-101n and/or one or more end terminals 107, to establish and/or modify one or more user profiles that specify content available to one or more secondary users. Further, system 100 alleviates the burden and expense upon network operators of providing parallel avenues to content, as well as controls for managing that media. Although the user equipment is described with respect to an STB, it is contemplated that various embodiments have applicability to any device capable of processing audio and/or video streams.

In a typical scenario, an individual (e.g., a subscriber of the content management service) may, via a client-user interface (such as a web-based application 109a implemented on server 105, a computing application 109b executed on, for instance, a PC, or a media-based application 109c operating on, for example, STB 101a), establish a user profile that is configured to present a selectable image corresponding to the user profile to a display (not illustrated) for selection by a second user, wherein the user profile specifies content that is available to the second user via a media-based device. Namely, subscribers are presented with an integrated presentation that includes customizable parameters governing content originating from a media service provider (MSP) 111 or a third-party source, and made available at STBs 101a-101n. In other words, guardians (e.g., a parent) may selectively make content available to one or more dependent users (e.g., a child), as well as schedule access to that media (in, for example, an a la carte fashion) by establishing content policies on a “per user” basis. As such, parents no longer have to constantly monitor their children, but instead may focus on selecting appropriate content for their children that will improve their learning experiences.

A content managing application (hereinafter “content manager”), such as content manager 109a, permits primary users to easily, effectively, and intuitively establish one or more user profiles that govern the presentation of personalized menus for customizing content (e.g., audio, video, gaming, and/or photographic media) made available to secondary users from content sources, including media service provider (MSP) 111, television broadcast systems 113, third party content provider systems 115, as well as content accessible over one or more data networks (e.g., service provider network 103, packet-based network 117, and/or telephony network 119), such as the content within content repository 121. Moreover, a separate identity for each communication device (e.g., STBs 101a-101n and/or one or more end terminals 107) associated with a subscriber's account may be established for further personalizing the content received by users comprising the account. Further, content managers 109a-109c may enable subscribers to specify scheduling information for access to the content made available.

In certain embodiments, one or more content managers 109a-109c can enable subscribers to create user profiles that are configured to present a selectable image corresponding to particular users to assist with the selection of an associated user profile. More specifically, the selectable image may include an image file (e.g., picture of a user) identifying particular profiles from one another. Alternatively (or additionally), distinguishing between profiles may be made possible via proper names, nicknames, usernames, or other suitable moniker for selecting associated user profiles, as well as personalization options, such as color settings, font settings, menu icons, etc. In other embodiments, content managers 109a-109c enable subscribers to specify information for matching educational content to particular users' aptitudes (e.g., abilities, skills, strengths, talents, etc.), interests (amusements, hobbies, occupations, obsessions, etc.), and/or weaknesses (inabilities, deficiencies, handicaps, shortcomings, etc.), so as to maximize the educational value of each users' multimedia experience. As such, embodiments of service provider network 103 may also enable individuals utilizing STBs 101a-101n (and/or end terminal(s) 107) to interact with one another, through personalized communications channels, to further facilitate the processes described herein.

Content can include any AV media (e.g., gaming applications, broadcast television programs, video-on-demand (VOD) programs, audio-on-demand (AOD) programs, pay-per-view programs, IPTV feeds, DVD related content, etc.), pre-recorded media content (e.g., DVR content), data communication services content (e.g., commercials, advertisements, videos, movies, songs, images, sounds, etc.), Internet services content (streamed audio, video, or pictographic media), and/or any other equivalent media form, such as locally stored content instances of the aforementioned media. In this manner, an MSP 111 may provide (in addition to their own media content) content obtained from sources, such as one or more television broadcast systems 113, one or more third-party content provider systems 115, content residing in a repository 121, accessible via server 105, or otherwise available via one or more packet-based networks 117 and/or telephony networks 111, as well as any other suitable avenue or source.

In particular embodiments, MSP 111 may comprise an IPTV system configured to support the transmission of television video programs from the broadcast systems 113 as well as other content, such as media content from the various third-party sources (e.g., components 101a-101n, 107, 115, 121) utilizing internet protocol (IP). That is, the IPTV system 111 may deliver signals and/or streams, including content, control commands, and/or user profile information, in the form of IP packets. Further, the transmission network (e.g., service provider network 103) may optionally support end-to-end data encryption in conjunction with the streaming and content management services, as will be explained in more detail below.

In this manner, the use of IP permits television services to be integrated with broadband Internet and gaming services, and thus, share common connections to a user site. Also, IP packets can be more readily manipulated, and therefore, provide users with greater flexibility in terms of control and personalization, as well as offer superior methods for increasing the availability of content from disparate sources. Delivery of AV content, control commands, and/or user profile information, by way of example, may be through a multicast from the IPTV system 111 to the STBs 101a-101n. Any individual STB may tune to a particular source by simply joining a multicast (or unicast) of the media content, control command, or user profile information, utilizing an IP group membership protocol (IGMP). For instance, the IGMP v2 protocol may be employed for joining STBs to new multicast (or unicast) groups. Such a manner of delivery avoids the need for expensive tuners to view media content, such as television broadcasts; however, other delivery methods, such as cable, may still be utilized. Further, this delivery method also enables varied levels of control, i.e., control over single STBs or broadcast control affecting multiple STBs. It is noted that conventional delivery methods may also be implemented and combined with the advanced methods of system 100. Further, the content (and subsequently the control commands and user profile information) may be provided to various IP-enabled devices, such as various computing, telephony, and mobile apparatuses delineated below.

An STB (e.g., STB 101a) may integrate all the functions of an IPTV system, as well as combine the content management and control functions of the various online or off-line environments, in a manner that seamlessly toggles among the various system 100 resources. It is contemplated that the remote service may be extended to users with a presence on the Internet. In alternative embodiments, the services of system 100 may be extended to users having an end terminal (not illustrated), such as a plain old telephone service (POTS) device, connected to the telephony network 119.

Accordingly, MSP 111 can provide content that is retrieved over a data network, as well as provide conventional media streams. For instance, MSP 111 provides STBs 101a-101n access to content traditionally limited to host sites, such as end user originated content uploaded to audio, video, and/or pictographic sharing sites. The content may also be shared between STBs 101a-101n, as well as between STBs 101a-101n and end terminal(s) 107. It is generally noted that media content can be any type of information provided from any source having connectivity to system 100.

In this manner, content managers 109b and 109c may be executable, for example, as a user interface capable of local implementation on an STB (e.g., STB 101a-101n) or on an end terminal 107, such as a computer, telephony device, mobile device, or other like mechanism. Thus, exemplary embodiments of content managers 109b and 109c may be provided through navigation shell applications, e.g., menu applications having options corresponding to different functions, as well as various content instances and/or multimedia experiences. To this effect, computing devices may include desktop computers, notebook computers, servers, terminal workstations, gaming systems, customized hardware, or other equivalent apparatus. Telephony devices may comprise plain-old-telephones, wireless telephones, cellular telephones, satellite telephones, voice over internet protocol telephones, and the like. Mobile devices may include personal digital assistants (PDA), pocket personal computers, smart phones, tablets, handsets, portable gaming systems, and customized hardware, as well as other mobile technologies capable transmitting data and/or processing audio/video signals. Moreover, STBs 101a-101n may be used alone or in combination with one or more end terminal(s) 107 to implement various exemplary embodiments.

The STBs 101a-101n and/or end terminal(s) 107 can communicate using the packet-based network 117 or the telephony network 119. These systems can include: a public data network (e.g., the Internet), various intranets, local area networks (LAN), wide area networks (WAN), the public switched telephony network (PSTN), integrated services digital networks (ISDN), other private packet switched networks or telephony networks, as well as any additional equivalent system or combination thereof. These networks may employ various access technologies including cable networks, satellite networks, subscriber television networks, digital subscriber line (DSL) networks, optical fiber networks, hybrid fiber-coax networks, worldwide interoperability for microwave access (WiMAX) networks, wireless fidelity (WiFi) networks, other wireless networks (e.g., 3G wireless broadband networks, mobile television networks, radio networks, etc.), terrestrial broadcasting networks, provider specific networks (e.g., a Verizon® FiOS® network, a TiVo® network, etc), and the like. Such networks may also utilize any suitable protocol supportive of data communications, e.g., transmission control protocols (TCP), internet protocols (IP), user datagram protocols (UDP), hypertext markup languages (HTML), dynamic HTML (DHTML), file transfer protocols (FTP), telnet, hypertext transfer protocols (HTTP), asynchronous transfer mode (ATM), wireless application protocols (WAP), socket connections (e.g., secure sockets layer (SSL)), Ethernet, frame relay, and the like, to connect STBs 101a-101n to various sources of media content and devices capable of remotely managing STBs 101a-101n.

By way of example, STB 101a-101n, as well as terminal(s) 107, can remotely access, via a communication interface (not illustrated), server 105 which can be configured to execute multiple instances of a content manager application 109a utilizing, for instance, one or more processors (not illustrated). That is, remote application 109a may be provided in a distributed fashion using, for instance, client-server architectures, such as implemented by enterprise application service providers (ASP). It is noted that ASP models (and other like architectures) offer system scalability in terms of administrative scalability, geographic scalability, and/or load scalability. Thus, distributed environments are attractive modes for disseminating system 100 functionality to a broad spectrum of users and devices.

For example, server 105 can be an “online” system capable of communicating with one or more third-party web servers (not illustrated), content repositories (e.g., repository 121), or equivalent facilities, to provide users various avenues to draw content from, as well as establish and modify one or more user profiles to control the content made accessible to particular users via, for example, STBs 101a-101n. More specifically, one or more servers 105 may include one or more processors configured to receive user input concerning one or more user profiles from one or more end terminals 107 (and/or STBs) for controlling content made available to one or more users at one or more STBs 101a-101n (and/or end terminal(s) 107), wherein the server(s), via the processor(s), are capable of configuring the user profile(s) according to the user input. In particular embodiments, this configuration can be performed in real-time, wherein the user input is transmitted to STBs 101a-101n to directly affect configuration data (e.g., user profile information) stored in a memory (not illustrated) of the respective media-based devices 101a-101n. Additionally (or alternatively), server(s) 105 can access a shared memory, such as repository 123, wherein STBs 101a-101n obtain sufficient configuration data from the shared memory, either in real-time or on a periodic basis.

As such, exemplary embodiments of remote application 109a may, for instance, comprise hypertext markup language (HTML) user interfaces or JAVA™ applets stored on server 105 and accessed via world-wide-web pages. Further, by enabling access and control of STBs 101a-101n over one or more data networks (e.g., network 103, 117, and/or 119) using a “web paradigm,” server 105 provides users with a convenient and efficient manner for configuring user profiles and associated content made available to the media-based devices 101a-101n. Further, remote applications 109a-109c may port local user interfaces typically utilized on stand-alone STBs to enable user input in a context consumers are increasing becoming familiar with due to the growing popularity of the Internet. These interfaces are particularly useful in extending system 100 functionality to devices having limited resources (e.g., PDAs, handsets, thin-clients, etc.), as well as providing scalable solutions to varied devices without necessitating intensive high-end costs associated with independent design, tooling, and manufacturing. In alternative embodiments, server 105 is collocated with and/or integrated into MSP 111. As such, multiple users, interfaces, and instances of content manager 109a can be simultaneously realized through system 100.

In one embodiment, STBs 101a-101n, end terminal(s) 107, and/or media managers 109a-109c may periodically establish a connection with one or more networks (e.g., networks 103, 117, and/or 119) and one or more repositories (e.g., repository 123) to “push” and “pull” content, user profile information, and/or control commands, such as in a “batched” processing mode. That is, a user interface of STBs 101a-101n may be virtualized over a networked connection. In another embodiment, these components may initiate peer-to-peer communications such that control input and configuration updates governing the user profile information are executed “on-the-fly,” i.e., in real-time, thus, enabling substantially instantaneous results.

In the example of FIG. 1, STBs 101a-101n may be located at one or more user premises, and geospatially associated with one or more regions. Further, the STBs 101a-101n may be logically associated into one or more workgroups, wherein a user may configure one or more user profiles to execute on a plurality of STBs 101a-101n arranged into the workgroups in one or more configuration sessions, utilizing one or more end terminals 107 or STBs (e.g., STB 101a).

For example, a learning institution (such as a secondary school) can distribute a plurality of STBs (e.g., STBs 101a and 101b) throughout various classrooms for extending customized content to an attending student body. An administrator (e.g., a principal) may establish one or more user profiles, via an end terminal 107 (e.g., a PC the principal's office) or at an associated STB (e.g., STB 101a) executing a content manager (e.g., content managers 109a-109c), so as to select and disseminate appropriate educational content instances (e.g., broadcast media, DVR media, on-demand media, or educational games, as well as locally stored instances of the same) to the students in particular classrooms, concerning various subject matter (e.g., science, math, social studies, physical wellbeing, etc.). Further, students maybe issued (or personally own) an STB at their home, e.g., STB 101n. As such, an authorized administrator can logically join STBs 101a-101n to a workgroup, wherein the plurality of STBs 101a-101n may be configured to present the customized educational content to an entire student body, wherein particular user profiles may match customized educational content to the aptitudes, interests, and/or weaknesses of each student, and provide access to this content on a scheduled basis, i.e., as the students progress from period-to-period, namely from one subject to another.

In other words, even if certain students were unable to attend school on particular days, every pupil could simply access their associated user profile via a media-based device (e.g., STB 101a-101n and/or one or more end terminal(s) 107) and follow a scheduled curriculum of customized content tailored to each individual student. As such, no student would be deprived of a learning opportunity. In this manner, the students may also be given authorization to access their profile to review the material later, via STBs 101a-101n or an end terminal 107 capable of processing audio and/or video signals, access additional content (e.g., interactive educational games) to build upon or reinforce previous lessons. As such, STBs 101a-101n may be associated with one or more subscribers, may be located in one or more user premises, and/or may be situated in different physical locations, but nevertheless, may provide access to one or more user profiles specifying content that is specifically made available to particular secondary users by an administrator.

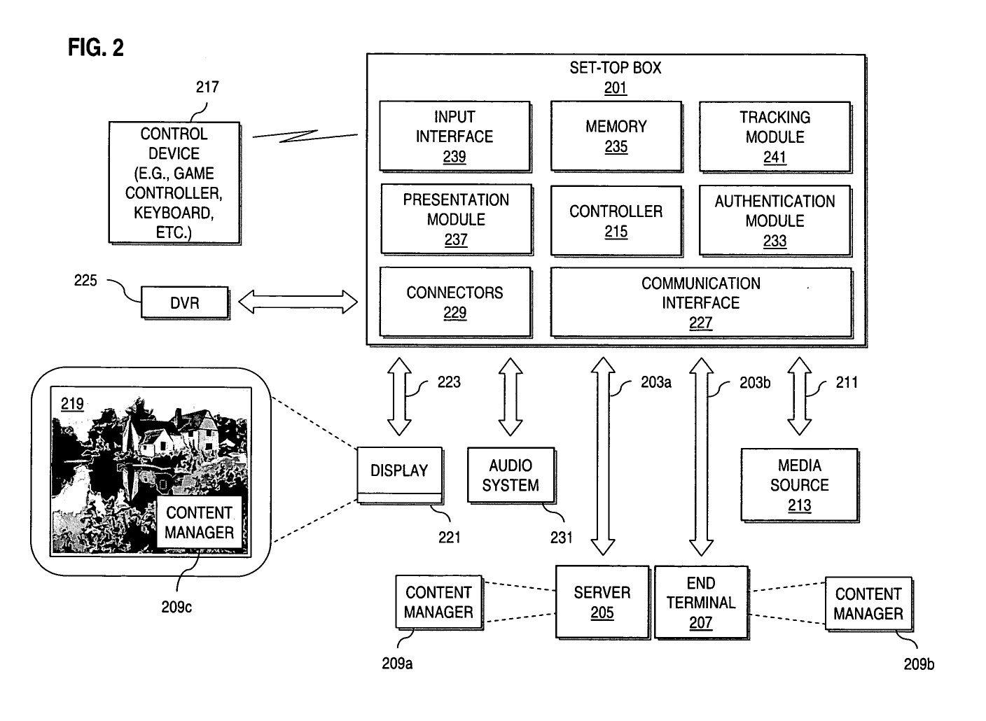

Thus, STBs 101a-101n can be configured to communicate with and receive signals and/or data streams from a MSP 111 (or other transmission facility, such as server 105, end terminal 107, etc.) in response to processes of one or more content managers 109a-109c. These signals include content, as well as user profile information and control commands transmitted over a data network (e.g., service provider network 103, packet-based network 117, and/or telephony network 119). To this effect, MSP 111 can include one or more content servers (not illustrated) and/or data repositories (not shown). Alternatively, user profile repository 123, content repository 121, or server 105 may be accessed via one or more service provider networks 103 and/or data networks (e.g., networks 117 and/or 119). Further, service provider network 103 may include a system administrator (not shown) for operational and management functions to deploy the remote management service using, for instance, an IPTV system. In this manner, STBs 101a-101n can utilize any suitable technology to draw, receive, and/or transmit content, user profile information, and control signals from/to an MSP 111 or other source/sink (e.g., server 105, end terminal 107, etc.). A more detailed explanation of an exemplary STB is provided with respect to FIG. 2.

In an exemplary embodiment, STBs 101a-101n can draw, receive, and/or transmit content, user profile information, and/or control commands from (or to) multiple sources/sinks, thereby alleviating the burden on any single entity, e.g., MSP 111, to meet the content, user profile, and control demands of any user, premise, or workgroup. Thus, particular embodiments enable authenticated third-party television broadcast systems 113, third-party content provider systems 115, and servers (e.g., server 105) to transmit content, user profile information, and/or control commands to STBs 101a-101n either apart from, or in conjunction with, MSP 111. The content, user profile information, and/or the control commands may be distinguished (or otherwise categorized) utilizing metadata included therewith or appended thereto. Metadata can be generally considered data about data; but more specifically, it can be utilized to describe all aspects of, and media content, user profile information, and/or control commands distributed by, system 100. Namely, metadata can include descriptions about: data aspects (file name, type, administrator, size, location, version, or include timestamps, mode bits, arbitrary attribute-value pairs, etc.), titles, activities/events, individuals and organizations involved, intended audiences (e.g., ethnicities, ages, genders, incomes, educational levels, disabilities, mobilities, as well as other like demographic statistics), geospatial identifications (intended zip codes, school districts, communities, regions, etc.), locations of supplementary information and processes, access methods, limitations, timing of activities/events/content availability (e.g., start/end times and dates), as well as motivations, policies and rules. As such, metadata may be utilized by various components of system 100 for control or guiding purposes.

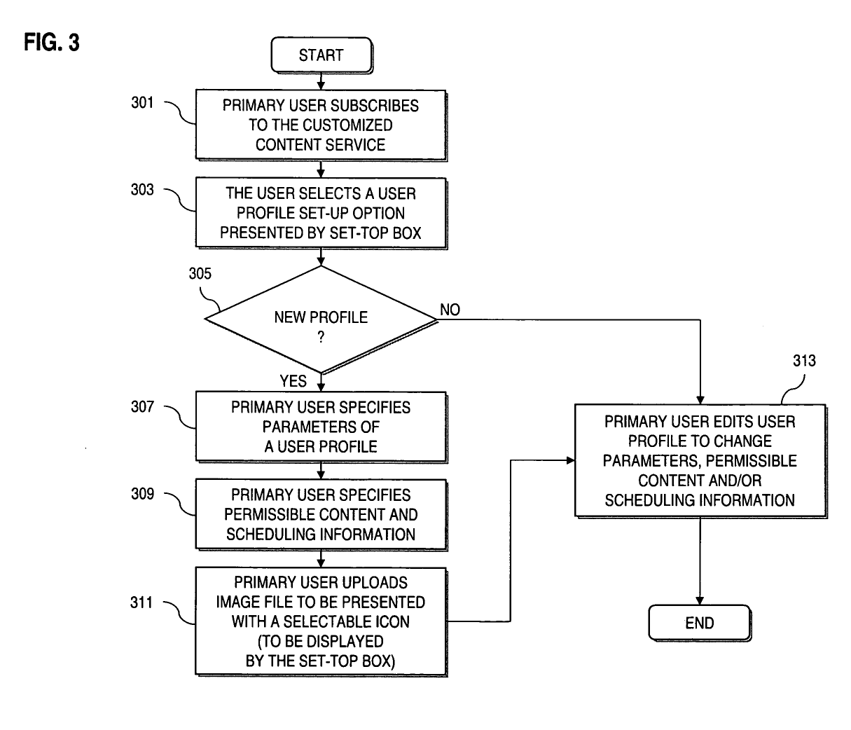

In certain embodiments, system 100 may structure and encode metadata to describe characteristics of the content-bearing entities to aid in the identification, discovery, assessment, and management of the content by content managers 109a-109c. For example, the metadata can be used to optimize compression algorithms or perform other computational tasks by the components of system 100. The metadata might be utilized to generate and/or transmit user profile information and/or control commands to a plurality of STBs 101a-101n. Various other embodiments might use metadata to suggest content sources of interest to a user based on information stored in a user profile. In other embodiments, metadata can be utilized to describe user profile information and/or control parameters governing content accessible to secondary users via STBs 101a-101n and/or end terminal(s) 107. A more detailed explanation of user profiles is provided with respect to FIG. 3.

In various embodiments, the service provider network 103 may include one or more video, audio, communication, and/or control command processing modules (not shown) for acquiring, generating, presenting, and/or transmitting content feeds, user profile information, and/or control commands from MSP 111, the television broadcast systems 113, the third-party content provider systems 115, servers 105, end terminals 107, or STBs 101a-101n, over one or more of the networks 103, 117, 119, to particular users at various STBs 101a-101n and/or end terminal(s) 107. Further, service provider network 101 can optionally support end-to-end data encryption in conjunction with media content streaming and remote access services such that only authorized users are able to experience customized content, establish one or more user profiles specifying content available to secondary users, and/or interact with other legitimate users/components of system 100.

Accordingly, system 100 may include an authentication module (not shown) configured to perform authentication services and determine whether users are indeed subscribers to the content management service. An authentication schema may require a user name and password, a key access number, a unique machine identifier (e.g., media access control (MAC) address, globally unique identifier (GUID), serial number), etc., as well as combinations thereof. In this manner, the authenticate module may be in communication with a user profile repository 123, which stores user credentials and personalized information for use by content managers 109a-109c. In particular embodiments, media-based devices 101a-101n and/or end terminal(s) 107 are provisioned for system 100 by associating a device identifier of the respective devices with respect subscriber accounts, where the accounts identify each of the media-based devices 101a-101n and/or end terminal(s) 107, as well as secondary user profiles under the control of a primary user and their primary profile.

In exemplary embodiments, a one time only provisioning authentication procedure is executed for each STB 101a-101n and/or end terminal(s) 107 by transmitting an associated machine identifier and user credentials to the authentication module. Thus, once a subscriber has authenticated a presence on system 100, the user may bypass additional authentication procedures for executing later applications (e.g., content streaming instances and/or content manager sessions). Data packets, such as cookies, may be utilized for this purpose. Thus, once an STB or content source is authenticated, connections between the STBs 101a-101n and the end terminal(s) 107 may be established directly or through server 105 and/or MSP 111.

In other embodiments, authentication procedures on a first device (e.g., STB 101a) may identify and authenticate a second (e.g., terminal 107) and/or a third device (STB 101b-101n) communicatively coupled to, or associated with, the first device. Further, the authentication module may grant primary users the right to control one or more user profiles, STBs 101a-101n, and/or end terminal(s) 107 serviced by service provider network 103 by revoking existing sets of digital certificates associated with a profile/STB/end terminal, and issuing new sets of digital certificates mapped to a second profile/STB/end terminal. In this regard, subscribers may start a new content manager sessions, whereas the previous session may be automatically closed when the “old” or prior certificates associated with the first session are revoked. This enables primary and secondary users to initiate secure sessions at any given end terminal 107 (or STB 101a-101n) linked to system 100, whether or not the end terminal (or STB) belongs to that individual user. It is additionally contemplated that multiple rights sessions may exist concurrently.

While system 100 is illustrated in FIG. 1, the components are exemplary in nature, and indeed, additional or alternative components and/or implementations may be utilized.

FIG. 2 is a diagram of a set-top box configured to provide managed content, according to an exemplary embodiment. STB 201 may comprise any suitable technology to receive user profile information (e.g., signals 203a and 203b) from a sever 205 and/or an end terminal 207, as well as from another STB (e.g., STB 101a). As such, STB 201 may also generate user profile information (including selectable images corresponding to particular user profiles and/or identifying secondary users, as well as customized content scheduling information) for specifying content to make available to the secondary users via STBs 101a-101n. The user profile information includes user input from a primary user and output from one or more content managers 209a-209c for presenting menus of customized content options (e.g., audio, video, gaming, and/or photographic media instances) to secondary users based on associated user profiles, wherein the processes of content managers 209a-209c may be performed “on-the-fly,” i.e., in real-time, or as the result of a “batched” request, i.e., periodically. STB 201 may further comprise suitable technology to receive one or more content streams 211 from a media source 213, such as the IPTV system of FIG. 1. The content stream 211 may be received in response to command(s) from content manager(s) 209a-209c and may include media, such as broadcast content, digital video recorder (DVR) content, on-demand content, on-demand games, and/or other suitable media, as well as locally stored instances of the same.

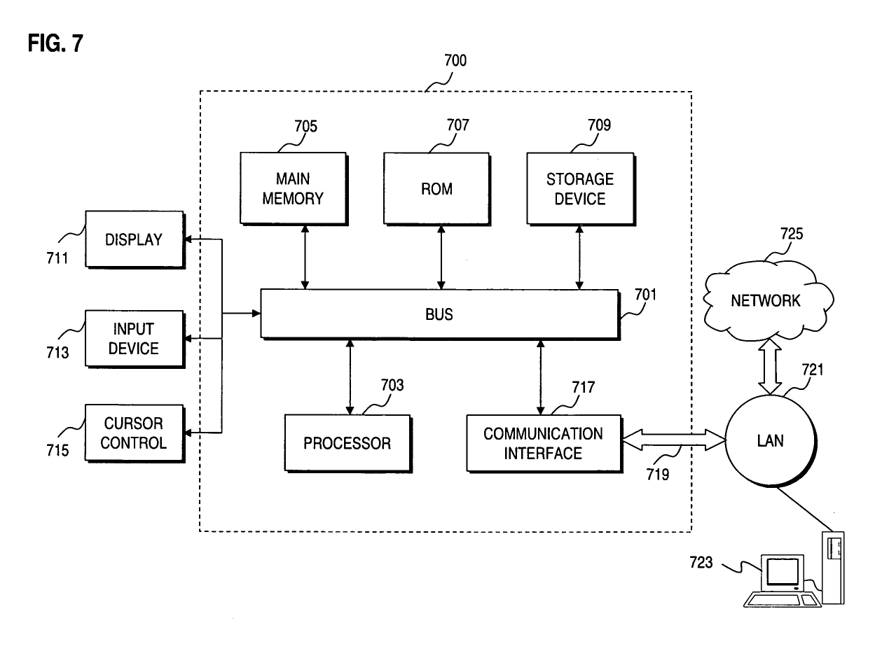

Accordingly STB 201 may comprise computing hardware (such as described with respect to FIG. 7) and include additional components configured to provide specialized services related to the generation, transmission, reception, and display of user profiles, user profile information, control commands, and/or content (e.g., user profile capabilities, conditional access functions, tuning functions, presentation functions, multiple network interfaces, AV signal ports, etc.). Alternatively, the functions and operations of STB 201 may be governed by a controller 215 that interacts with each of the STB components to configure user profiles in response to control commands from content managers 209a-209c, as well as provide media content retrieved from media source 213. Additionally, a user may be afforded greater functionality utilizing a control device 217 to control these services, as will be more fully described below.

As such, STB 201 may be configured to process data streams (e.g., streams 203a, 203b, and 211), including causing a content manager 209c and/or one or more components of received content (e.g., video component 219 and/or an audio component) to be presented on (or at) a display 221. Presentation of the content may be in response to a command received from one or more content managers 209a-209c and include: displaying, recording, playing, rewinding, forwarding, toggling, selecting, zooming, or any other processing technique that enables users to select customized content instances from a menu of options and/or experience content. For instance, STB 201 may provide one or more signals 223 to a display 221 (e.g., television) so that the display 223 may present (e.g., display) content manager 209c overlaid on the content (e.g., video 219) to a user, wherein the content manager 209c enables a first user to establish a user profile that includes a selectable image corresponding to the user profile for selection by a second user, wherein the user profile specifies content that is available to the second user via STB 201 or end terminal(s) 107. Alternatively, signals 223 may be configured and provided to display 221 in response to a received control command from a content manager 209a or 209b. In certain embodiments, the user profile also specifies scheduling information for access to the specified content.

STB 201 may also interact with a PVR, such as digital video recorder (DVR) 225, to store received content that can be manipulated by a user at a later point in time. In various embodiments, DVR 225 may be network-based, e.g., included as a part of the service provider network 103, collocated at a subscriber site having connectivity to STB 201, and/or integrated into STB 201. In any case, content managers 209a-209c may port content instances provided by DVR 225 into a customized menu of content options available to secondary users based on associated user profiles and scheduling information established by a primary user. A display 221 may present content provided via STB 201 to a user. In alternative embodiments, STB 201 may be configured to communicate with a number of additional peripheral devices, including: PCs, laptops, PDAs, cellular phones, monitors, mobile devices, handheld devices, as well as any other equivalent technology capable of presenting managed content to a user, such as those computing, telephony, and mobile apparatuses described with respect to FIG. 1.

These peripherals may be configured to access user profile information and/or managed content stored and/or processed by STB 201 in response to control commands from content managers 209a-209c. For example, a content stream 211 may be received by STB 201 and recorded by DVR 225, wherein a user at a PC may later access and view the stored content based on a customized menu of content options, scheduling information, and/or any other control command of one or more content managers 209a-209c. Moreover, the peripheral devices may be configured to implement instances of a content manager (e.g., content manager 209b) to control, configure, or otherwise program user profile information and/or available content to users of STB 201. For instance, a content manager 209b executed on end terminal 207 may receive input from a primary user specifying user profile information, including selectable images corresponding to particular user profiles and scheduling information, as well as content to make available to secondary users via STB 201. An associated control command, generated based on the input, may be received at a communication interface 227, wherein STB 201 retrieves the user profile information, selectable image, scheduling information, and associated managed content for presentation to the user via display 221. In another embodiment, a communication interface (not illustrated) of end terminal 207 may be configured to retrieve the user profile information, selectable image, scheduling information, and/or associated managed content over, for instance, a data network (e.g., packet-based network 105), wherein STB 201 may receive a data stream 203b from end terminal 207 including the retrieved user profile information, selectable image, scheduling information, and/or associated managed content to present to a secondary user via display 221.

In another embodiment, user input to STB 201 and/or a peripheral device (e.g., end terminal 207) executing an instance of a content manager (e.g., content manager 209c and/or 209b) may cause specified content (e.g., an on-demand game) to be made available at another STB (e.g., STB 101a-101n) or a computing, telephony, or mobile device capable of processing audio and/or video streams. Still further, user input to a network-based remote application 209a, implemented on, for instance, server 205, may be configured to program or otherwise control available content and/or multimedia entertainment instances of STB 201. For instance, a user may access content manager 209a, via an end terminal 107, over one or more data networks (e.g., network 103, 117, and/or 119), to transmit user profile information, including selectable images, scheduling information, and information specifying customized content to make available to particular secondary users, via STB 201. In this manner, server 205 (or other component of system 100, such as MSP 111) may, when suitable, transmit the user profile information and specified content instances as a part of stream 203a to STB 201 for presentation at display 221.

Communication interface 227 may be configured to receive user profile information from server 205, end terminal 207, MSP 111, or another STB (e.g., STB 101a). In turn, specified content may be streamed from a media source 213 (e.g., MSP 111, television broadcast system 113, content provider system 115, and/or repository 121), an end terminal 207, and/or server 205 and be received at communication interface 227. In particular embodiments, communication interface 227 may optionally include single or multiple port interfaces. For example, STB 201 may establish a broadband connection to multiple sources transmitting data to STB 201 via a single port, whereas in alternative embodiments, multiple ports may be assigned to the one or more sources. In still other embodiments, communication interface 227 may transmit user profile information (including selectable images, customized content menu options, and/or content scheduling data), as well as associated customized content instances (e.g., a game) to other users with STBs, an MSP 111, or any other suitable source/sink, such as end terminal 207.

According to various embodiments, STB 201 may also include inputs/outputs (e.g., connectors 229) to display 221 and DVR 225, as well as an audio system 231. In particular, audio system 231 may comprise a conventional AV receiver capable of monaural or stereo sound, as well as multichannel surround sound. Audio system 231 may include speakers, ear buds, headphones, or any other suitable component configured for personal or public dissemination. As such, STB 201, display 221, DVR 225, and audio system 231, for example, may support high resolution audio and/or video streams, such as high definition television (HDTV) or digital theater systems high definition (DTS-HD) audio. Thus, STB 201 may be configured to encapsulate data into a proper format with required credentials before transmitting onto one or more of the networks of FIG. 1, and de-encapsulate incoming traffic to dispatch data to display 221 and/or audio system 231.

In an exemplary embodiment, display 221 and/or audio system 231 may be configured with internet protocol (IP) capability (i.e., include an IP stack, or otherwise made network addressable), such that the functions of STB 201 may be assumed by display 221 and/or audio system 231 and controlled, in part, by content manager command(s). In this manner, an IP ready, HDTV display or DTS-HD audio system may be directly connected to one or more service provider networks 103, packet-based networks 117, and/or telephony networks 119. Although STB 201, display 221, DVR 225, and audio system 231 are shown separately, it is contemplated that these components may be integrated into a single component, or other combination of components.

An authentication module 233 may be provided at STB 201 to initiate or respond to authentication schemes of, for instance, service provider network 103 or various other content providers, e.g., broadcast television systems 113, third-party content provider systems 115, or servers 105. Authentication module 233 may provide sufficient authentication information, e.g., a user name and password, a key access number, a unique machine identifier (e.g., GUID or MAC address), and the like, as well as combinations thereof, to a corresponding network interface for establishing connectivity. As described earlier, one or more digital certificates may be simultaneously mapped. Moreover, authentication at STB 201 may identify and authenticate a second device (e.g., end terminal 207) communicatively coupled to, or associated with, STB 201, or vice versa. Further, authentication information (as well as user profile information) may be stored locally at memory 235, in a repository (not shown) connected to STB 201, or at a remote repository, e.g., user profile repository 123.

Authentication module 233 may also facilitate the reception of data from single or disparate sources. For instance, STB 201 may receive broadcast video from a first source (e.g., IPTV system 111), signals from a content manager 209a at second source (e.g., server 205), and a content stream (e.g., an on-demand game) from a third source accessible over a data network (e.g., content repository 121). As such, display 221 may present the broadcast video, content manager 209a, and on-demand game to a secondary user, wherein STB 201 (in conjunction with one or more content managers 209a-209c) can permit primary users to control the content available to secondary users at STB 201 and/or end terminal(s) 107. This presentation may be experienced separately, concurrently, in a toggled fashion, or with zooming, maximizing, minimizing, or trick capabilities, or equivalent mode. In other exemplary embodiments, authentication module 233 can authenticate a user to allow them to specify scheduling information for access to the specified content at other STBs (e.g., STB 103a-103n), as well as configuring selectable images to correspond to associated secondary users/user profiles.

A presentation module 237 may be configured to receive data streams 203a, 203b, and 211 (e.g., AV feed(s) and/or control commands) and output a result via one or more connectors 229 to display 221 and/or audio system 231. In this manner, presentation module 237 may also provide a user interface for content manager 209a or 209c via display 221. Aural aspects of content managers 209a or 209c may be presented via audio system 231 and/or display 221. In certain embodiments, content managers 209a or 209c may be overlaid on the video content output 219 of display 221 via presentation module 237. In any case, however, the data streams may include user profile information (including scheduling information) received in response to a secondary user selecting a specified content instance available based on an associated user profile, including media, such as broadcast content, digital video recorder (DVR) content, on-demand content, on-demand games, and/or other suitable media, as well as locally stored instances of the same.

Connector(s) 229 may provide various physical interfaces to display 221, audio system 231, as well as other peripherals; the physical interfaces may include, for example, RJ45, RJ11, high definition multimedia interface (HDMI), optical, coax, FireWire, wireless, and universal serial bus (USB), or any other suitable connector. The presentation module 237 may also interact with a control device 217 for configuring user profiles, as well as determining particular content instances that a user desires to experience. In an exemplary embodiment, the control device 217 may comprise a game controller, a keyboard, and/or a remote control (or other access device having control capability, such as end terminal 207, e.g., a PC, wireless device, mobile phone, etc.) that provides a user with the ability to readily manipulate and dynamically change parameters affecting user profile information and/or a multimedia experience (e.g., playing an on-demand game). Such parameters can include STB 201 configuration data, such as parental controls, available channel information, favorite channels, program recording settings, viewing history, or loaded software, as well as other suitable parameters.

In particular embodiments, configuration data may also include channel fixing options, show/hide/label channel functions, making captions or info banners available, label inputs (such as connector(s) 229) options, application graphics settings (e.g., color schemes, icons, etc.), high altitude settings, power saving modes, device password options, country/language options, display settings (e.g., AV parameters), control functions (e.g., channel up/down. input, mute, pause, picture-in-picture, play, power on/off, rewind, fast-forward, record, stop, volume up/down), parental locks, application settings (e.g., memory sticks, i.links, clocks/timers, diagnostics, cable card), change operating system functions, or install software, as well as provide troubleshooting frequently asked questions, get device manuals, or receive safety tips, etc. It is generally noted that configuration data can be any option/feature available at STB 201, DVR 225, or peripheral device (e.g., display 221, audio system 231, control device 217, etc.) having connectivity to (or association with) STB 201.

In this manner, control device 217 and/or end terminal 207 may include (not shown) a cursor controller, trackball, touch screen, touch pad, keyboard, and/or a key pad for activating content managers 209a-209c, navigating through broadcast channels and/or content, as well as establishing user profiles and performing other processes as described herein. For instance, control device 217 or end terminal 207 may be utilized to maximize a content manager, navigate through displayable interfaces including selectable images associated with particular user profiles, locate/specify/retrieve content made available based on a user profile specified by a primary user, modify user profile information, adjust STB 201 configuration data, or toggle through available broadcast channels and/or content. Control device 217 or end terminal 207 may also include functional actuators (e.g., buttons, keys, icons, etc.), such as power on/of, play, pause, stop, fast-forward, reverse, volume up/down, channel up/down, menu, ok/enter, record, info, my content, search, edit, or exit, as well as any other suitable control trigger, such as alphanumeric buttons, shift, control, back, symbols, and the like. In other examples, STB 201 may be configured for voice recognition such that STB 201 may be controlled with spoken utterances entered into a content manager (e.g., content manager 209c).

Further, the control device 217 or end terminal 207 may comprise a memory (not illustrated) for storing preferences (or user profile information) affecting the content available, which can be conveyed to STB 201 through an input interface 239 (or communication interface 227). Input interface 239 may support any type of wired and/or wireless link, e.g., infrared, radio frequency (RF), BLUETOOTH, and the like. Thus, control device 217 and/or end terminal 207 may store user preferences with respect to managed content, such as favorite sources, etc., as well as user profile information, including selectable images associated with particular user profiles and/or scheduling information for making specified content available. Alternatively, user preferences and user profile information may be tracked, recorded, or stored in STB 201, via memory 235, or in a network user profile repository 123. A tracking module 241 may be provided for this purpose, as well as monitoring content usage statistics (e.g., date and time spent experiencing particular content instances) for effecting scheduling information and associated content availability parameters associated therewith. The preferences and user profile information may be automatically retrieved and activated by a primary and/or one or more secondary users at any time, or may be actuated in response to user profile information (including scheduling information) received via content managers 209a-209c. It is noted that control device 217 may be separate from STB 201 or may be integrated within STB 201 (in which case certain input interface hardware and/or software may not be necessary).

Exemplary embodiments enable primary users, via one or more content managers 209a-209c and control device 217 (or an input interface of one or more end terminals 207), to populate or otherwise configure a user profile that is configured to present a selectable image corresponding to the user profile for selection by a secondary user, wherein the user profile specifies content that is available to the secondary user. For instance, a user profile function of a content manager(s) 209a-209c may be provided or accessed by STB 201/end terminal 207 to enable users to populate a plurality of entry fields with user information. A user profile may include one or more customized or personalized settings that affect any aspect of content accessible to secondary users via STB 201, configuration parameters, or option of a peripheral device. More specifically, the profile may include: subscription information (account numbers, usernames, passwords, security questions, avatars, selectable images, image files identifying associated users, monikers, etc.), subscriber demographics (age, gender, ethnicity, location of residence, zip code, school district, community, socioeconomic status, religion, marital status, ownerships, languages, mobility, life cycles, etc.), group/organizational affiliations (e.g., political), memberships, interests, buddies, friends, cohorts, system configurations, policies, associated users/devices, etc., as well as any other like personal information.

In other embodiments, profile information can include phone numbers, email addresses, workgroups, viewing history (e.g., current programming, logged history, etc.) account plan, authorized access to specified content, scheduling information governing access to specified content, billing preferences (e.g., bill receipt options, such as electronic or paper bills, payment methods, such as automatic or manual, etc.), add accounts/users, parental controls, etc. Additionally, a user profile may include a “whitelist” specifying one or more accessible media content sources/subjects, a “blacklist” specifying one or more media content sources/subjects, as well as other equivalent customized settings, such as color schemes, sound effects, etc. Still further, network settings may be affected such as registering associated STBs, DVRs, end terminals, registering premises (e.g., primary residence, vacation cottage, work, etc.), link to content sources (e.g., audio, video, and/or pictographic sites/systems/repositories, etc.), as well as other equivalent parameters, such as available broadcast content, DVR content, on-demand content, on-demand games, or locally stored instances of the same.

In other embodiments, the user profile may be established, reviewed, and/or modified using the additional access devices described earlier, e.g., end terminal 207, such as a PC, implementing or accessing one or more content managers 209a-209c. As such, user profile information and configuration data may be stored in STB 201, e.g., in memory 235, and/or at a user site repository (not illustrated) directly connected to STB 201. Additionally or alternatively, this information may be stored in a network-based repository (e.g., remote user profile repository 123), control device 217, and/or any other accessible storage medium, such as a memory stick, or other database. Similarly, STB 201 (via memory 235), a user site repository, and/or a network-based repository may store a collection of digital audio, video, game, and/or pictographic content accumulated by a user. This collection may also include a plurality of identifiers (or bookmarks) to specified content made available based on a user profile established via content manager(s) 209a-209c, wherein the selection of a particular identifier may cause the content to be retrieved from an associated link (either directly from a third party source (e.g., television broadcast system 113, content provider system 115, content repository 121, etc.) or indirectly from server 105, MSP 111, end terminal 107, another STB 101a-101n, etc.).

Thus, under arrangements of FIGS. 1 and 2, a primary user may establish, via an STB (e.g., 101a), end terminal 107, or server 105 application, one or more user profiles that are configured to present selectable images corresponding to associated user profiles to a display for selection by one or more secondary users, wherein the user profile specifies content (including matched education content, e.g., an educational game) that is available to the secondary users, as well as scheduling information for access to the content. The operation of STB 201 and one or more remote applications 209a-209c, in conjunction with the components of system 100, will now be described with respect to remotely controlling and configuring one or ore STBs and one or more subscription service options. According to one embodiment, automated scripts can be triggered to update the user profiles automatically based on predefined rules or scripts. For example, the predefined rules can modify the profile to better adapt to the viewing habit of the user or adapt to the requirements or policies of the secondary (e.g., supervisory) user.

As there may be a relatively large number of configurable user profile parameters available to users, STB 201 may include one or more user interfaces configured to allow subscribers to seamlessly access associated user profile information, via one or more content managers 209a-209c. As such, a menu of customized content options (e.g., audio, video, gaming, and/or photographic media instances) may be presented to a secondary user based on an associated user profile established by a primary user via the content managers 209a-209c. It is recognized; however, that one or more user interfaces may be implemented at one or more end terminals 207 or accessible via one or more servers 205 or MSPs 111. Thus, the user interface may be displayed to the user as part of a content manager accessible over a suitable communications link. Namely, web pages may be displayed to the user as part of an online remote application accessed over an Internet communications link. Exemplary processes and user interfaces for those processes are described in more detail with respect to FIGS. 3-6.

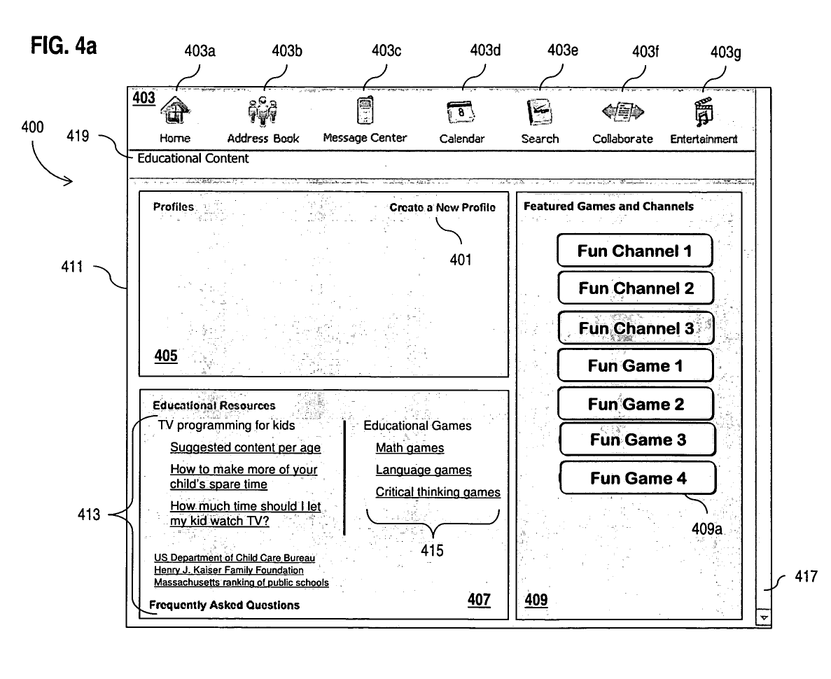

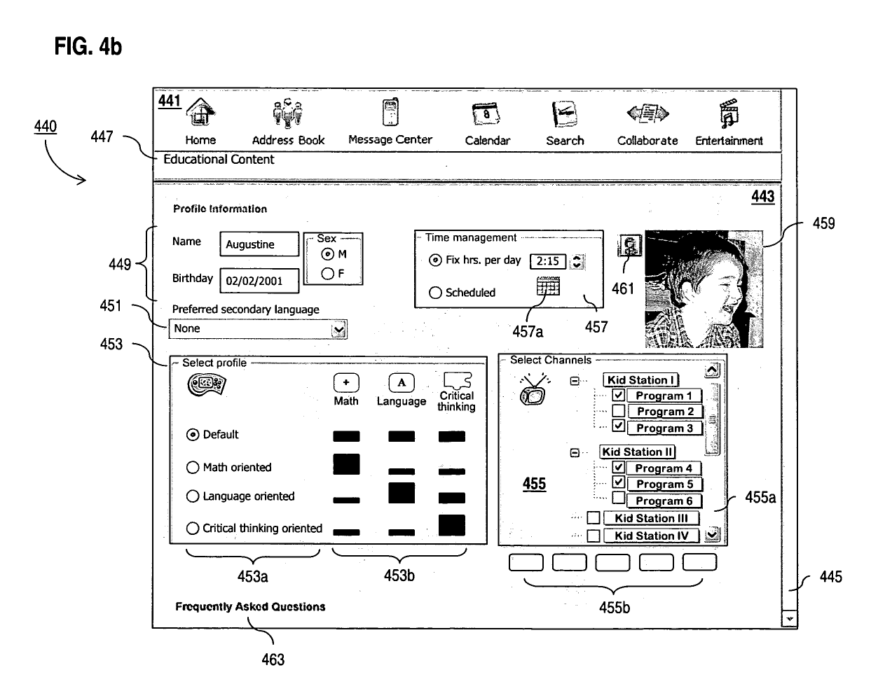

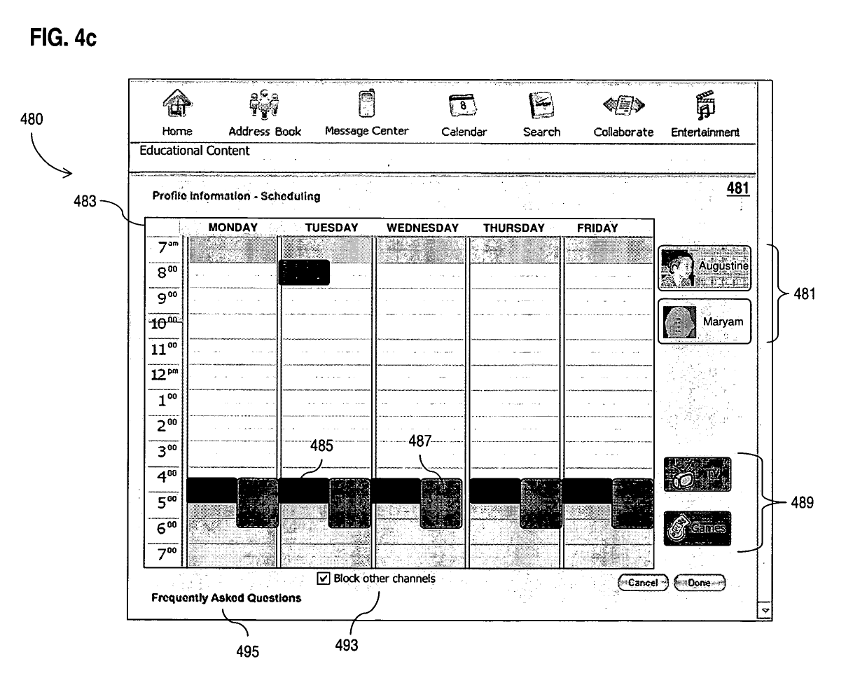

FIG. 3 is a flowchart of a process for establishing and/or editing a user profile, according to an exemplary embodiment. This process is described with respect to exemplary user interfaces of FIGS. 4a-4c. In step 301, a new user subscribes to the content management service utilizing, for instance, an end terminal 207, which is capable of processing and transmitting data over a network (e.g., packet-based network 117). That is, the user may interact with an input interface (described in more detail with respect to FIG. 7) of end terminal 207 to activate software resident on the device, such as content manager 209b executed on end terminal 207 or web-based content manager 209a implemented on server 205. The software may then establish one or more connections to a service provider network 103 through an IP-based connection. Consequently, the user may register as a new subscriber of the content management service, as well as obtain sufficient authentication information for establishing future sessions.

In certain embodiments, registration procedures may prompt the user to identify all user devices (e.g., STBs 101a-101n and/or end terminal(s) 107) that the user may employ to interact with system 100 features, e.g., content managers 209a-209c. The software may automatically search for peripheral devices, e.g. through a pinging or other suitable procedure, as well as port any peripheral configuration parameters or user interface information into, for instance, user profile repository 123 for access by content managers 209a-209c. In other embodiments, the user may identify devices by entering appropriate device information, such as: device type, serial number, registration number, MAC address, GUID, phone number, communications link, etc. In this manner a new subscriber may establish a separate identity for each media-based device 101a-101n and/or end terminal(s) 107 associated with the user, which may be utilized to further personalize the content received by secondary users of the subscribing account.

As such, MSP 111, server 105, and or one or more content managers 209a-209c may obtain device configuration parameters from a manufacturer or other third-party supplier over, for instance, the packet-based network 117. Further, when a new device is employed, the software may add the apparatus to the list of user devices associated with the user's account. To this effect, registered devices (such as one or more STBs 101a-101n) may be logically associated with one another. That is, STBs 101a-101n can be grouped into workgroups such that associated subscription accounts, i.e., primary user profiles and one or more secondary user profiles, governing the availability of content to the associated users may be established, wherein the user profiles specify content that is available to the associated users and scheduling information for making the content available, as well as selectable images corresponding to the associated users/user profiles for selecting (or discriminating between) various profiles.

Once registered and/or authenticated, the user may select a user profile set-up option, per step 303. That is, the user via end terminal 207, via content manager 209a and/or 209b, may establish communication with MSP 111 for establishing one or more user profiles, i.e., primary profiles and one or more secondary profiles, wherein each user profile embodies user-defined attributes, policies, configuration data, scheduling information, selectable images, premises, and/or workgroups for carrying out functions of system 100. Thus, when the user authenticates a presence via, for instance, an STB 201, the software may provide user-specific interfaces and features based on information stored within the user profile. Moreover, authentication procedures at one device (e.g., end terminal 107) may authenticate other devices (e.g., STBs 101a-101n), as previously described, or vice versa. In other embodiments, users may subscribe to the remote management service and/or populate a user profile via STB 201, utilizing an input interface, such as control device 217 and/or end terminal 207, via content managers 209a and/or 209c.

As seen in FIG. 4a, an exemplary user interface 400 for selecting a user profile set-up option 401 is illustrated. To this effect, an authenticated subscriber (e.g., a parent) may directly review and/or edit user profile information (e.g., secondary profiles of, for instance, one or more children), including information, such as selectable images associated with distinct profiles, parameters specifying content that is to be made available on a per profile basis, scheduling information for making the content available, as well as the various other profile inputs previously described with respect to FIG. 2. User interface 400 may be invoked using a number of different methods. For example, the user may select a dedicated “MENU” button on control device 217 or on a peripheral device communicatively coupled thereto (or associated therewith), such as end terminal 207. It is recognized that any other suitable actuator of these devices may be additionally, or alternatively, used to access the functionality of interface 400, such as triggering a “GUIDE” icon or other suitable graphical element. Further, interface 400 may be evoked by selecting an option within another interface or application (e.g., when navigating from a public screen to a user-specific screen, i.e., a private screen). As such, an executing device (e.g., STB 201, server 205, end terminal 207, etc.) may require sufficient authentication information (e.g., username, password, MAC address, GUID, etc.) to be input in order to access the functions of interface 400.

In the illustrated embodiment, user interface 400 may include one or more interactive panes, such as panes 403-409. In particular embodiments, as will be described in more detail below, the content of respective panes may be dynamically updated to display various information related to actions conducted within other panes, and vice versa. Pane 403 (i.e., a options pane) includes a listing of selectable entries corresponding to one or more features (or options) that may be associated with a subscription service or provided via STB 201 and/or end terminal 207. For example, entries might include: a home (i.e., main menu) option 403a, an address book option 403b, a message center option 403c, a calendar option 403d, a search option 403e, a collaborate option 403f, and an entertainment option 403g, as well as other suitable entries. In certain embodiments, graphical elements may be provided to correspond to one or more of the entries, and may be displayed therewith to facilitate interface usability. In other embodiments, pane 403 may include a navigation tree, an expandable table of contents, or FlashMedia presentation of selectable entries. Based on a particular selection within pane 403, a main window pane 411 may be populated with appropriate input fields, selectable elements (e.g., toggle buttons, check boxes, radio buttons, sliders, list boxes, spinners, drop-down lists, menus, toolbars, ribbons, combo boxes, icons, etc.), output fields (e.g., labels, tooltips, balloon helps status bars, progress bars, infobars, etc.) and additional windows/panes, as well as any other suitable interface widget for inputting (or otherwise perceiving) configurable parameters. In turn, actions within main window 411 may affect selectable parameters within pane 403.

As seen, main window 411 includes: pane 405 (i.e., a profile establishing pane), pane 407 (i.e., an educational resources pane), and pane 409 (i.e., a featured games, channels, or other content pane). In this manner, pane 407 comprises, for instance, a plurality of links (or bookmarks) for researching content to make available to one or more secondary users that will edify the users' multimedia experience. These links may connect the user to information stored at MSP 111 or another third party source (such as a website) having educational or other content resource information. For example, links 413 may provide users with information, such as suggested content for certain age groups, ways to maximize secondary users “spare” time, or how much time should be allotted to a secondary user for interacting with various multimedia resources available via STB 201, as well as other suitable information, such as public school rankings, frequently asked questions, etc. Further, links 415 can be provided to inform primary users about certain educational games, such as math games, language games, critical thinking games, as well as other suitable interactive learning applications. As such, primary users may consult pane 407 to acquire expert knowledge concerning content to make available to one or more secondary users to maximize their multimedia learning experience.

Similarly, pane 409 may be provided to include, for example, featured programming, broadcast channels, on-demand media, on-demand games, DVR content, or locally stored instances of the same, most often selected by other subscribers to the content management service, as well as new availabilities of the same. Thus, primary users may consult pane 409 to acquire insight into what other subscribers are making available to secondary users. Additionally (or alternatively), information within pane 409 may be populated based on metadata correlation (matching) between user profile information and available content (such as educational content) provided by the one or more content sources of system 100. According to certain embodiments, one or more selectable graphical icons corresponding to featured content may be provided, wherein users may acquire knowledge regarding the particular content instance being suggested. For instance, selection of graphical icon 409a may provide information regarding a particular broadcast channel, including: rating information, plot summaries, lesson plans, interactive capabilities, messages, characters, etc., from which the primary user may determine whether such content is suitable or appropriate to make available to one or more secondary users. Again, this information may be provided as a result of metadata application.

In turn, pane 405 can provide profile information, as well as a set-up profile option 401 for configuring one or more secondary profiles. Further, pane 405 may provide selectable entries corresponding to previously established user profiles, wherein selection of such an entry may enable users to delete and/or edit existing user profiles/user profile information. In this manner, when a user navigates to a desired entry, actuation of, for instance, a “CREATE A NEW PROFILE” option 401 may launch corresponding user interfaces for populating and/or editing one or more user profiles. User interfaces launched in response to user interaction with set-up user profile option 401 are described with respect to FIGS. 4b and 4c.

In other embodiments, aural descriptions, tooltips, or other effects may be provided when a user navigates, for instance, a cursor over particular fields of panes 403, 405, 407, and/or 409. Additionally (or alternatively), interface 400 may be configured to accept verbal commands for entering suitable data into entry fields or making selections within the respective panes. In particular embodiments, interface 400 may include fields (not illustrated) for targeted advertisements generated based on metadata concerning information within a user profile, or content available at one or more STBs 101a-101n, as well as other suitable fields, such as a field for an MSP logo, etc. Moreover, navigational elements/fields, e.g., scrollbar 417, as well as heading field 419, may be provided and configured to indicate the existence of additional entries not displayed, but navigably available, as well as facilitate interface usability. Accordingly, users may browse to these entries via, for instance, an input interface of end terminal 207, e.g., a cursor control, or actuation of a respective control device 217 component.

Referring back to FIG. 3, user selection of a user profile set-up option causes one or more content managers 209a-209c to determine whether the user intends to establish a new profile, i.e., per step 305. If the user intends to configure a new profile, the process of FIG. 3 successively toggles through steps 307-313; otherwise the process jumps to an edit user profile step 313. Assuming the primary user interacts with the “CREATE A NEW PROFILE” set-up option 401 of user interface 400, one or more content managers 209a-209c may launch user interface 440 of FIG. 4b, wherein the primary user may specify user profile information, including various configurable parameters, such as selectable images corresponding to particular user profiles, information specifying content to make available to one or more secondary users, as well as access user interface 480 of FIG. 4c governing scheduling information for access to the specified content, per step 307.

As such, step 307 enables users, via one or more end terminal(s) 207 and/or STB 201, executing one or more content managers 209a-209c, to transmit a signal to an interface, e.g., a communication interface, of service provider network 103, server 105, user profile repository 123, etc., based on the user profile information input to the content managers 209a-209c. More specifically, the transmitted signal may be received at an interface of user profile repository 123 directly or indirectly via an interface of, for instance, MSP 111 or server 105, wherein one or more of these interfaces (via one or more processors) can configure associated user profiles based on the received signal. Such configuration may be executed in real-time, thus having substantially immediate effect on the user's account, and consequently on available content at STBs 101a-101n. Alternatively, configuration processes may be executed periodically via established connections with one or more networks (e.g., networks 103, 117, or 119) and one or more repositories (e.g., repository 123) to “push” and “pull” user profile information, such as in a “batched” processing mode.

In any case, exemplary user interface 440 (of FIG. 4b) enables primary users to configure secondary user profile information. Similarly to interface 400, interface 440 may include one or more interactive panes, such as panes 441 and 443, that may be dynamically updated to display various information and/or fields related to actions conducted within the respective panes. Pane 441, i.e., the options pane 403 of FIG. 4a, includes various selectable entries corresponding to one or more features (or options) that may be associated with a subscription service or provided via STB 201 and/or end terminal 207, and may be accompanied by suitable graphical elements corresponding to the one or more entries. Based on selection of the “CREATE A NEW PROFILE” set-up option 401 of FIG. 4a, pane 443 may be populated with appropriate input fields, selectable elements, output fields, and/or windows, as well as any other suitable interface widget for inputting (or otherwise perceiving) configurable user profile information. In turn, actions within pane 443 may affect selectable parameters within pane 441, and vice versa.

In certain embodiments, aural descriptions, tooltips, or other effects may be provided when a user navigates, for instance, a cursor over particular fields of panes 441 and 443. Additionally (or alternatively), interface 440 may be configured to accept verbal commands for entering suitable data into entry fields or making selections within the respective panes. In particular embodiments, interface 440 includes fields (not illustrated) for targeted advertisements, content available at one or more STBs 101a-101n, as well as other suitable fields, such as a field for an MSP logo, etc. Moreover, navigational elements/fields, e.g., scrollbar 445, as well as heading field 447, may be provided and configured to indicate the existence of additional entries not displayed, but navigably available, as well as facilitate interface usability. Accordingly, users may browse to these entries via, for instance, an input interface of end terminal 207, e.g., a cursor control, or actuation of a respective control device 217 component.

Pane 443 (i.e., a profile information pane) includes various input fields 449-459 for users to input various user profile parameters. Particular actions within the various fields can dynamically modify the display of various information within the interested field and/or the other respective fields based on actions conducted within the respective panes. Field 449 may enable users, via one or more input interfaces of end terminal(s) 107, STB 201, and/or control device 217, to enter personal information, such as a secondary user's name, birthday, and gender, as well as other suitable personal information corresponding to those parameters previously delineated with respect to FIG. 2. A language field 451 (implemented as, for instance, a drown-down list) allows the primary user to control preferred secondary languages of one or more secondary user interfaces, specified content instances (e.g., on-demand games), etc., so as to increase the secondary users' familiarity and/or proficiency with multiple languages.

Field 453 (i.e., a profile selection field) permits users to choose between one or more pre-established profile policies 453a designed to distribute (or portion) a secondary user's multimedia experience between various technical categories, such as math oriented development, language oriented development, critical thinking oriented development, as well as other technical fields, such as science, history, social studies, cognitive awareness, memory recognition, etc. One or more selection fields, e.g., radio buttons, check boxes, etc., may be provided for selection of a technical category focus area. In other embodiments, field 453 may include a navigation tree, an expandable table of contents, or FlashMedia presentation of selectable entries. Moreover, a plurality of graphical displays 453b may visually illustrate the distribution between the various technical categories as a function of the selection of a particular technical category. For instance, a default setting may be selectively available, wherein a secondary user's entertainment experience may be evenly distributed between each of the available technical categories. Thus, a corresponding graphical display may illustrate, for instance, evenly sized bars, wherein the size of a particular bar relates to the relative exposure of the secondary user with the various technical categories. In alternative embodiments, relative exposure may be conveyed through percentages, pie charts, sized icons, color codes, etc. Further, a primary user may be permitted to construct their own distribution between various available (or user specified) technical categories.

As such, metadata descriptions concerning specified content may be utilized by the content managers 209a-209 to control the availability of certain content instances based on the subject matter of the content with respect to a technical category policy. Additionally, these metadata descriptions may be utilized in conjunction with statistical content usage parameters to control content availability based on the selected technical category policy.

As seen in FIG. 3, the primary user may implement interface 440 to also specify permissible content and scheduling information, per step 309. Thus, interface 440 also includes field 455, a content specification field, to allow primary users to specify content to make available to particular secondary. As illustrated, field 455 enables the primary user to select, via one or more selection fields (e.g., check boxes, radio buttons, etc.), a plurality of listed broadcast channels to make available to the secondary user. In other embodiments, field 455 may include a navigation tree, an expandable table of contents, or FlashMedia presentation of selectable entries. In this manner, a local navigation element, e.g., scrollbar 455a, may be provided and configured to indicate the existence of additional entries not displayed, but navigably available. Further, a plurality of tabs 455b may enable users to toggle content selection modes of field 455 between broadcast content selection, DVR content selection, on-demand media (e.g., audio, pictographic, and/or video content) selection, on-demand game selection, or locally stored instances of the same.

In conjunction with the various modes of field 455, a time management field 457 may be provided to control the scheduling availability of the selected content within field 455 based on, for example, absolute time values, times of day, day of the week, weeks of month, months of year, etc., as well as any other suitable time management parameter. Selectable fields, e.g., radio buttons, check boxes, etc., may be provided to select between these various modes. Further, a schedule builder option 457a can be provided for scheduling these time management parameters, as well as scheduling access to particular content (e.g., on-demand games versus broadcast programming) and/or access to STB 201, as a function of one or more secondary users. The schedule builder option 457a is explained in more detail with respect to FIG. 4c.

Accordingly, when a user interacts with the schedule builder option 457a, pane 443 of interface 440 is dynamically updated to pane 481 of interface 480. As depicted, pane 481 includes an exemplary scheduling widget 483, including a conventional calendar display (e.g., a display including a current day, week, month, year, etc., having scheduling time periods) and various content scheduling blocks (e.g., block 485 and 487) corresponding to time periods wherein a secondary user may access particular content instances. Thus, a primary user may specify scheduling information by simply interacting within (e.g., clicking on) a particular display period (e.g., day of the week). As such, an additional “pop-up” field (not illustrated) may be provided wherein a user may choose between various available time slots, or may specify particular scheduling information (e.g., start/end dates, times, etc.) in input regions of the pop-up field. In particular embodiments, scheduling information may be made as a singular instance or as recurring events. Reminders may be provided, as well as distinctive coloring options to correspond to particular users and/or available content. Thus, the pop-up field may also include selectable parameters for specifying applicable profiles, content instances, devices, etc., for establishing scheduling information. A content legend 489 and a user profile legend 491 are included to identify the intended meaning of certain graphical depictions of scheduler widget 483. In this manner, legends 489 and 491 promote visual and conceptual clarity. A “BLOCK OTHER CHANNELS” option 493 and/or “BLOCK OTHER CONTENT” option (not illustrated) may be provided to limit secondary user access to only those content instances specifically scheduled for availability.

Referring back to FIG. 3, the primary user (at step 311) may upload an image file to be presented as a selectable icon, wherein the image file is intended to correspond to particular secondary users and their associated user profile. The selectable image can include an image file identifying the user (e.g., a headshot, avatar, or other visual artifact), such that the image file can be shown to secondary users to assist with the selection of the user's particular user profile. As such, interface 440 (of FIG. 4b) also includes a selectable image field 459 and an upload image option 461, for configuring a selectable image corresponding to the user profile. User interaction with (e.g., clicking on) the upload image option 461 enables a user to browse a memory (e.g., memory 235 of STB 201, user profile repository 123, content repository 121, or other accessible memory, e.g., a memory of one or more end terminals 207, a database of MSP 111 or other third party source, etc.) and choose an image file to associate with a particular user profile, and in some embodiments, store therein. Conventional uploading techniques may be utilized for this purpose. Accordingly, selectable image field 459 may be provided to convey a “successful” association (i.e., upload), as well as demonstrate what the selectable image will “look like.”

Additionally, user interfaces 440 and/or 480 may include a frequently asked questions feature 463 and 495, respectively, to aid user decisions and/or inputs. In this manner, at step 313 (of FIG. 3) a user may be permitted to edit user profile information and/or parameters, including modifying personal information, preferred secondary languages, profile policies, available content, scheduling information, selectable images, and the like, of the various user profiles. After generating and/or editing a user profile, MSP 111 may store a list of subscribers to the service, as well as a list of subscriber STB identifiers, authentication information, and user-defined profiles (including user-specific policies, subscription service options, and/or configuration data) for one or more STBs 101a-101n and associated peripheral devices (e.g., display 221, audio system 231, etc.). Additionally (or alternatively), users may directly interact with user profile repository 123. Further, user profile information may be stored within respective user equipment (e.g., STBs 101a-101n) via a memory 235 or other repository (e.g., a locally accessible database coupled to STB 201, or a content repository accessible over a data network, such as repository 121).

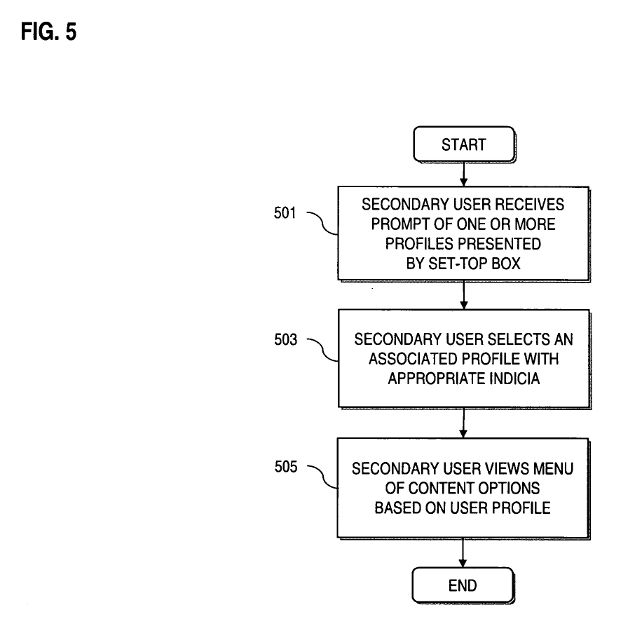

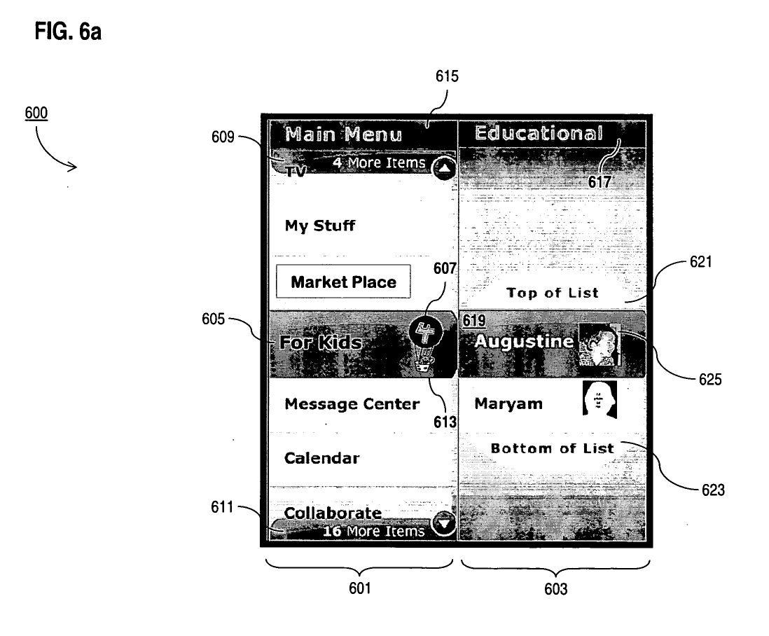

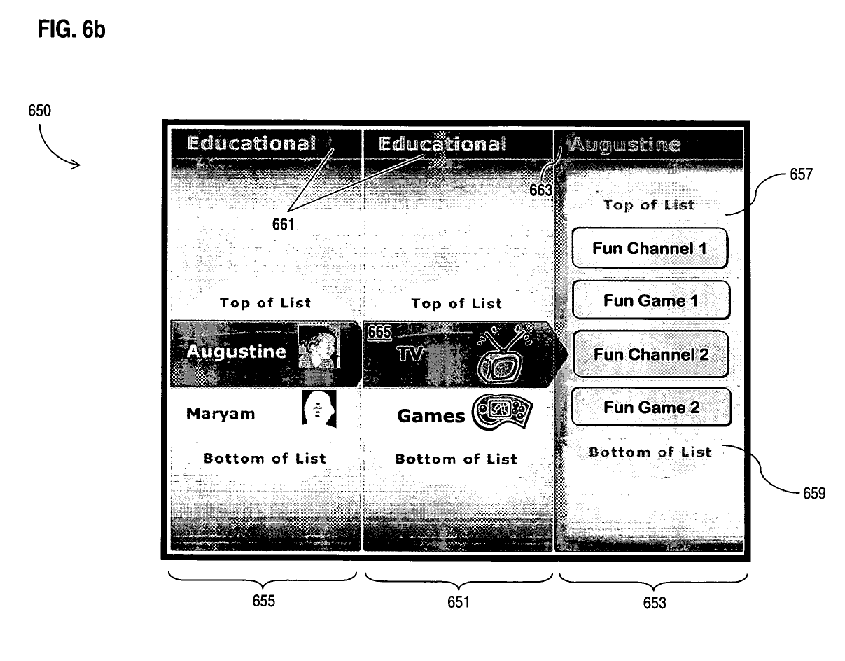

As such, one or more user profiles corresponding to one or more secondary users may be established by primary users via one or more content managers 209a-209c utilizing one or more end terminals 207 and/or one or more STBs 101a-101n. In turn, the content managers 209a-209c may utilize information stored within the respective profiles to present a menu of customized content options (e.g., audio, video, gaming, and/or photographic media instances) to the secondary users. FIG. 5 is a flowchart of a process for presenting a menu of content options based on a selected user profile, according to an exemplary embodiment. FIGS. 6a and 6b are diagrams of exemplary user interfaces configured for this purpose.

In step 501, an authenticated secondary user may receive a prompt at display 221, via STB 201, corresponding to one or more available profiles specifying media (e.g., broadcast content, DVR content, on-demand media (audio, pictographic, and/or video content), on-demand games, or locally stored instances of the same) that is available to the secondary user for their selection. For instance, FIG. 6a is a diagram of a main menu prompt (i.e., user interface) of set-top box 201, according to an exemplary embodiment. The main menu 600 interface may be evoked using a number of different methods. For example, the user may select a dedicated “MENU” button on control device 217 or a peripheral device communicatively coupled thereto or associated therewith (e.g., PC 221, a mobile handset, etc.). It is recognized that any other suitable actuator of these devices may be additionally, or alternatively, used to access the functionality of main menu 600, such as triggering a “GUIDE” icon. Further, main menu 600 may be evoked by selecting an option within another interface or application (e.g., when navigating from a public screen to a user-specific screen, i.e., a private screen). As such, an executing device (e.g., STB 201, PC 221, etc.) may require sufficient authentication information (e.g., username and password, etc.) to be input in order to access the functions of main menu 600.

As shown, interface (or screen) 600, providing a “Main Menu,” may include one or more interactive viewing panes, such as panes 601 and 603. In this manner, the display of pane 603 may be dynamically updated to display various information related to actions conducted within pane 601, and vice versa. Pane 601 includes a listing of selectable entries corresponding to one or more features (or options) that may be provided via STB 201. For example, entries might include: program guide listings, DVR options, marketplace (shopping) options, messaging and communications features, searching options, calendar features, settings, help features, collaboration features, and the like, as well as “FOR KIDS” 605 options. In certain embodiments, graphical elements (e.g., element 607) may be provided to correspond to one or more of the entries, and may be displayed therewith.

Header 609 and footer 611 fields may be provided and configured to indicate the existence of additional entries not displayed, but navigably available. Accordingly, users may browse through these entries via, for instance, control device 217. A fixed focus state (e.g., border/box 613) and/or distinctive magnification features, e.g., color, brightness, bolding, font type, text size, etc., may be used to convey a “currently” navigated position. In this manner, when a user navigates to a desired entry, actuation of, for instance, an “OK” button on control device 217 may launch corresponding features and/or applications of the particular entry. In some embodiments, a displayed interactive “OK” option (not shown) may be utilized. Moreover, main menu 600 may include tooltips (not illustrated) when a user navigates to a particular entry. In other embodiments, an aural description of the entry navigated to and methods of interaction may be provided.

In other embodiments, main menu 600 may provide navigation fields 615 and 617 to facilitate usability. For example, field 615 may provide the name of the function/option being accessed, e.g., “MAIN MENU.” In this manner, when a user accesses a new function/option, field 615 can be automatically updated, as is apparent in, for example, FIG. 6b. Field 617 may be utilized to indicate the user sub functions/options being accessed, e.g., “EDUCATIONAL” content functions. Thus, a secondary user may access their user profile via pane 603 by navigating to and selecting entry 605 of main menu 600.

Per step 503, the secondary user can distinguish between various user profiles via appropriate indicia, such as a username, selectable image corresponding to the user profile, or other personalized information, such as those parameters stored within the user profiles. Secondary header 621 and footer 623 fields may be provided and configured to indicate the existence of additional user profiles not displayed, but navigably available. In the depicted embodiment, header 621 and footer 623 fields respectively display “TOP OF LIST” and “BOTTOM OF LIST,” thus demonstrating the existence of a set of selectable profiles limited to those displayed. It is contemplated that any number of profiles may exist. Accordingly, users may browse through these entries via, for instance, control device 217, and select their associated profile via, for instance, selectable image 625. Doing so may cause user interface 600 to be dynamically updated to interface 650 of FIG. 6b. In some embodiments, additional authentication procedures may be required to access one or more secondary profiles, so as to keep over inquisitive users from accessing content not appropriate or unintended for them.

At step 505, the secondary user may view one or more menus of customized content options (e.g., audio, video, gaming, and/or photographic media instances), e.g., such as those menus illustrated in interactive panes 651 and 653 of FIG. 6b. As seen in FIG. 6b, a secondary user may view customized content options identifying available content via interface 650. More specifically, interface 650 may comprise panes of a content manger, such as content manager 209c. As previously described with respect to earlier interfaces, panes 651-655 include displays that may be dynamically altered in response to user interaction. Further, header and footer fields (e.g., header 657 and footer 659) may be provided to facilitate micro-navigation, as previously described. Fields 661 and 663 may be provided to facilitate macro-navigation, as previously described. In the depicted embodiment, fields 661 provide the name of the function/option being accessed, e.g., “EDUCATIONAL” material. Meanwhile, field 663 indicates the user profile of the current session, e.g., “AUGUSTINE.”

As such, pane 651 may include a list of navigably available content categories, e.g., broadcast programming, DVR content, on-demand media, on-demand, games, or locally stored instances of the same. In certain embodiments, graphical elements may be provided to correspond to one or more of the entries, and may be displayed therewith. Accordingly, users may browse through these entries via suitable method (e.g., using control device 217). A fixed focus state (e.g., border/box 665) and/or distinctive magnification features may be used to convey a “currently” navigated position. In this manner, when a user navigates to a desired entry, the display of pane 653 may toggle between corresponding available content instances to experience. Selection of, for example, a “TV” content category within pane 651, makes various specified broadcast programming instances available to the secondary user in pane 653, for selecting and experiencing, via STB 201, display 221 and/or audio system 231.

The processes described herein for providing content management for a set-top box may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 7 illustrates computing hardware (e.g., computer system) 700 upon which an embodiment according to the invention can be implemented. The computer system 700 includes a bus 701 or other communication mechanism for communicating information and a processor 703 coupled to the bus 701 for processing information. The computer system 700 also includes main memory 705, such as a random access memory (RAM) or other dynamic storage device, coupled to the bus 701 for storing information and instructions to be executed by the processor 703. Main memory 705 can also be used for storing temporary variables or other intermediate information during execution of instructions by the processor 703. The computer system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computer system 700 may be coupled via the bus 701 to a display 711, such as a cathode ray tube (CRT), liquid crystal display, active matrix display, or plasma display, for displaying information to a computer user. An input device 713, such as a keyboard including alphanumeric and other keys, is coupled to the bus 701 for communicating information and command selections to the processor 703. Another type of user input device is a cursor control 715, such as a mouse, a trackball, or cursor direction keys, for communicating direction information and command selections to the processor 703 and for controlling cursor movement on the display 711.

According to an embodiment of the invention, the processes described herein are performed by the computer system 700, in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the embodiment of the invention. Thus, embodiments of the invention are not limited to any specific combination of hardware circuitry and software.

The computer system 700 also includes a communication interface 717 coupled to bus 701. The communication interface 717 provides a two-way data communication coupling to a network link 719 connected to a local network 721. For example, the communication interface 717 may be a digital subscriber line (DSL) card or modem, an integrated services digital network (ISDN) card, a cable modem, a telephone modem, or any other communication interface to provide a data communication connection to a corresponding type of communication line. As another example, communication interface 717 may be a local area network (LAN) card (e.g. for Ethernet™ or an Asynchronous Transfer Model (ATM) network) to provide a data communication connection to a compatible LAN. Wireless links can also be implemented. In any such implementation, communication interface 717 sends and receives electrical, electromagnetic, or optical signals that carry digital data streams representing various types of information. Further, the communication interface 717 can include peripheral interface devices, such as a Universal Serial Bus (USB) interface, a PCMCIA (Personal Computer Memory Card International Association) interface, etc. Although a single communication interface 717 is depicted in FIG. 7, multiple communication interfaces can also be employed.

The network link 719 typically provides data communication through one or more networks to other data devices. For example, the network link 719 may provide a connection through local network 721 to a host computer 723, which has connectivity to a network 725 (e.g. a wide area network (WAN) or the global packet data communication network now commonly referred to as the “Internet”) or to data equipment operated by a service provider. The local network 721 and the network 725 both use electrical, electromagnetic, or optical signals to convey information and instructions. The signals through the various networks and the signals on the network link 719 and through the communication interface 717, which communicate digital data with the computer system 700, are exemplary forms of carrier waves bearing the information and instructions.

The computer system 700 can send messages and receive data, including program code, through the network(s), the network link 719, and the communication interface 717. In the Internet example, a server (not shown) might transmit requested code belonging to an application program for implementing an embodiment of the invention through the network 725, the local network 721 and the communication interface 717. The processor 703 may execute the transmitted code while being received and/or store the code in the storage device 709, or other non-volatile storage for later execution. In this manner, the computer system 700 may obtain application code in the form of a carrier wave.

The term “computer-readable medium” as used herein refers to any medium that participates in providing instructions to the processor 703 for execution. Such a medium may take many forms, including but not limited to non-volatile media, volatile media, and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While the preferred embodiments have been described herein, alterations thereto, and other embodiments and implementations of the invention as set forth in the attached claims are possible. Accordingly, the scope of the invention is not limited to the description provided herein, but rather covers various modifications and equivalent arrangements.

The following patent application is incorporated herein by reference in its entirety: co-pending U.S. patent application Ser. No. (Attorney Docket No. 20070246) filed ______, entitled “Method and System for Performance Tracking to Modify Content Presented by a Set-top Box.”

What is claimed is:

1. A method comprising:
receiving via an online user interface an input, at a set-top box, from a parental user for creating a user profile of a dependent user on the set-top box that is configured to present a selectable image corresponding to the user profile to a display for selection by the dependent user, wherein the user profile specifies educational content that is available to the dependent user and associated scheduling information for accessing the educational content, the educational content including games and video programming; and
receiving, via the online user interface from the parental user, information for matching the educational content to aptitude or interest of the dependent user.

2. A method according to claim 1, wherein the user profile is updated automatically according to a predefined rule specified by the parental user.

3. A set-top box device comprising:
a communication interface configured to receive an input, at a set-top box, from a parental user for creating a user profile of a dependent user; and
a presentation module configured to present a selectable image corresponding to the user profile to a display for selection by the dependent user, wherein the user profile specifies educational content that is available to the dependent user and associated scheduling information for accessing the educational content, the educational content including games and video programming,
wherein the communication interface is further configured to receive from the parental user information for matching the educational content to aptitude or interest of the dependent user.

4. A set-top box device according to claim 3, wherein the user profile is updated automatically according to a predefined rule specified by the parental user.

5. A method comprising:
establishing, by a first user, a user profile on a set-top box that is configured to present a selectable image corresponding to the user profile to a display for selection by a second user,
wherein the user profile specifies content that is available to the second user.

6. A method according to claim 5, wherein the content includes broadcast content, digital video recorder (DVR) content, on-demand video, on-demand games, or locally stored games.

7. A method according to claim 5, further comprising:
receiving parameters for the user profile via a remote control device.

8. A method according to claim 5, further comprising:
receiving parameters for the user profile via a computer configured to communicate with the set-top box over a data network.

9. A method according to claim 5, wherein the user profile further specifies scheduling information for access to the content.

10. A method according to claim 5, further comprising:
establishing, by the first user, another user profile on the set-top box for a third user.

11. A method according to claim 5, wherein the first user is a parent and the second user is a child.

12. A method according to claim 5, wherein the user profile further specifies information for matching educational content.

13. A method according to claim 5, wherein the selectable image includes an image file identifying the second user, the image file being shown to the second user to assist with the selection of the user profile.

14. A method according to claim 5, wherein the user profile is updated automatically according to a predefined rule.

15. A set-top box apparatus comprising:
a memory configured to store a user profile that is established by a first user; and
a presentation module configured to present a selectable image corresponding to the user profile to a display for selection by a second user, wherein the user profile specifies content that is available to the second user.

16. An apparatus according to claim 15, wherein the content includes broadcast content, digital video recorder (DVR) content, on-demand video, on-demand games, or locally stored games.

17. An apparatus according to claim 15, further comprising:
an input interface configured to receive parameters for the user profile via a remote control device configured to control the apparatus.

18. An apparatus according to claim 15, further comprising:
a communication interface configured to communicate with a computer over a data network for receiving parameters for the user profile over a data network.

19. An apparatus according to claim 15, wherein the user profile further specifies scheduling information for access to the content.

20. An apparatus according to claim 15, wherein the memory is further configured to store another user profile that is established by the first user for a third user.

21. An apparatus according to claim 15, wherein the first user is a parent and the second user is a child.

22. An apparatus according to claim 15, wherein the user profile further specifies information for matching educational content.

23. An apparatus according to claim 15, wherein the selectable image includes an image file identifying the second user, the image file being shown to the second user to assist with the selection of the user profile.

24. An apparatus according to claim 15, wherein the user profile is updated automatically according to a predefined rule.

25. A system comprising:
a database configured to store content for delivery to a set-top box based on a user profile; and
a video processor configured to transmit video content to the set-top box over a transmission facility,
wherein the set-top box is configured to present a selectable image corresponding to a user profile that is established by a first user to a display for selection by a second user, wherein the user profile specifies content, including the video content, that is available to the second user.
